(19) United States
(12) Patent Application Publication
(10) Pub. No.: US 2025/0225277 A1
(43) Pub. Date: Jul. 10, 2025

(54) SENSITIVE DATA PROTECTION

(71) Applicant: BUBBLR INC., London (GB)

(72) Inventor: Stephen MORRIS, Sheridan, WY (US)

(21) Appl. No.: 19/055,968

(22) Filed: Feb. 18, 2025

(51) Int. Cl. G06F 21/62

(52) U.S. Cl. CPC G06F 21/6254

(57) ABSTRACT

A method and system is disclosed which enable sensitive data to be protected during interactions with a generative model.

### FIELD

The invention relates to a method and system. Particularly, but not exclusively, the invention relates to a computer-implemented method and system. Particularly, but further not exclusively, the invention relates to a computer implemented method for processing a request to a generative model.

### BACKGROUND

Generative artificial intelligence (GAI) is growing in popularity as a way of producing content. It utilises trained models which are used to generate content such as text, images and even audio. GAI has introduced efficiency and automation into various sectors. However, the use of such technology within regulated industries and data-sensitive organisations presents a substantial risk.

Over 30% of companies have implemented outright bans on GAI applications due to concerns over inadvertent data leaks. For example, if a multinational financial institution drafts confidential bid documentation using a GAI system, the risk of this data being transmitted externally is unacceptable. Consequently, organisations are unable to capitalise on the productivity and automation advantages of AI while maintaining regulatory compliance and data security.

Aspects and embodiments were conceived with the foregoing in mind.

### SUMMARY

Aspects relate to a system that allows organisations to safely integrate generative AI while ensuring sensitive data remains protected within the confines of their internal network.

Viewed from a first aspect, there may be provided a computer-implemented method of processing a request to a generative model. The request may comprise one or more prompts to the generative model. The request may also comprise one or more identifiers corresponding to one or more generative models. A generative model may be described as a trained model which can be used to generate content such as, for example, images, text, audio, music and video using a foundation model. The method may be implemented by a processing resource. The processing resource may be any processing configuration which can provide processing capacity and may be software or hardware implemented.

The method may comprise providing a platform configured to process one or more prompt inputs. The platform may be provided by providing computer-executable instructions to one or more processors which may be part of the processing resource or may be distinct from the processing resource. The computer-executable instructions, when executed by the one or more processors, configure the platform in accordance to perform the steps set out below. The platform may be configured to receive a request comprising one or more prompt inputs from a computing device, wherein the request is directed to the generative model. The request may be received from one or more computing devices or via a user interface provided via the platform. That is the request comprises one or more prompts which identify one or more generative models. A prompt may be described as a natural language instruction or question which is provided to a generative model to generate a response. The platform may be configured to apply pre-processing to the prompt to apply prompt engineering techniques to structure or craft the instruction for the one or more identified generative models which are identified in the prompt. The platform may process the one or more prompt inputs to identify one or more sensitive data items associated with the prompt input. One or more neural networks may be applied to process the one or more prompt inputs to identify the one or more sensitive data items. The association may be identified in more than one way. Association may be the presence of sensitive data items such as, for example, names and addresses. Association may also be identified where the prompt references sensitive data by way of an indication in the prompt which identifies sensitive data, e.g. by explicit or implicit reference to a sensitive data field. Text analysis techniques may also be applied to process the one or more prompt inputs to identify the one or more sensitive data items. Sensitive data items may be defined in a database accessible by the platform. The database and its associated data may be stored locally to the platform. The database may be updated based on user input or automatically based on data received from a device such as, for example, a web crawler which is configured to determine terms which have become sensitive. Sensitive data items may be described as data items which refer to personal information which could cause harm, discrimination, or other adverse consequences if it is disclosed, misused or accessed without authorisation. Sensitive data items may be described as data items which could cause commercial harm if disclosed, misused or accessed without authorisation. Examples of sensitive data may include companies, people, places, locations, products, projects names, percentages, countries, monetary values, percentages, measurements, numbers, parameters, parameter definitions, numerical ranges and compositions Sensitive data items may be identified based on context. Context may be determined by any appropriate technique such as, for example natural language processing or context clustering. Sensitive data items may be identified using one or more artificial neural networks (ANNs). The platform may anonymise the identified sensitive data items prior to forwarding the prompt input to the generative model to form an anonymised prompt input. The anonymisation of data may be described as the removal of any components which can be used to identify a subject. The platform may forward the request to the generative model, wherein the request comprises the anonymised prompt input. The method may further comprises receiving the response to the request from the generative model and processing the response to replace anonymised content in the response with the corresponding one or more sensitive data items.

A method in accordance with the first aspect enables secure adoption of generative AI within data-sensitive environments, ensures compliance with regulatory requirements for data protection and confidentiality, prevents unauthorised exposure of proprietary or classified information, maintains enterprise-level visibility and control over AI interactions, facilitates safe and efficient AI-assisted operations without reliance on external security measures.

This system and method provide a robust and scalable framework for enabling generative AI within regulated industries while mitigating the risks associated with data leaks and unauthorised access.

Optionally, anonymising the identified sensitive data items may comprise replacing the identified sensitive data items with anonymised data.

Optionally, the anonymised data may be generated by processing the identified sensitive data item to generate an anonymised form of the identified sensitive data item,

Optionally, the generation of the anonymised form of the identified sensitive data item comprises generating a hash of the identified sensitive data item.

Optionally, the anonymised form may be generated based on an anonymisation indicator stored in a client environment.

Optionally, the identification of sensitive data items may be based on one or more user-defined terms or inputs.

Optionally, the identification of sensitive data items may be performed using a trained neural network. The trained neural network may be an artificial neural network (ANN).

Optionally, specific sensitive terms can identified as highly sensitive, and for these highly sensitive terms, they must always be redacted and desensitised. However, system administrators associated with the organisation and/or a system implementing the method may identify roles (or issue credentials) that allow some users to issue generative AI queries that permit the non-redaction of these super-sensitive (or highly sensitive) terms.

Optionally, when a highly sensitive term is utilised in a non-redacted AI query by a permitted user, a notification process may be initiated to alert nominated administrators of such an event.

ANNs can be hardware-(neurons are represented by physical components) or software-based (computer models) and can use a variety of topologies and learning algorithms. ANNs usually have at least three layers that are interconnected. The first layer consists of input neurons. Those neurons send data on to the second layer, referred to a hidden layer which implements a function and which in turn sends the output neurons to the third layer. There may be a plurality of hidden layers in the ANN. With respect to the number of neurons in the input layer, this parameter is based on training data.

The second or hidden layer in a neural network implements one or more functions. For example, the function or functions may each compute a linear transformation or a classification of the previous layer or compute logical functions. For instance, considering that the input vector can be represented as x, the hidden layer functions as h and the output as y, then the ANN may be understood as implementing a function ƒ using the second or hidden layer that maps from x to h and another function g that maps from h to y. So, the hidden layer's activation is ƒ(x) and the output of the network is g(ƒ(x)).

Anonymisation of the one or more sensitive data items may be based on a mapping between the sensitive data item and an anonymised form of the sensitive data item.

Optionally, the platform may be configured to be accessed via a containerised environment associated with user data.

Optionally, the method may further comprise processing the prompt input to identify time-sensitive or dynamic data.

Optionally, the method may further comprise determining whether the time-sensitive or dynamic data is associated with at least one sensitive data item.

Optionally, the method may further comprise processing the time-sensitive or dynamic data to generate an anonymised form of the time-sensitive or dynamic data.

Optionally, the method may further comprise processing the response to replace anonymised time-sensitive or dynamic content with corresponding one or more time sensitive or dynamic data items.

Optionally, the response may be provided on a computing device via a user interface. The computing device may be provided with application code which, when executed by a processing resource, configure the computing device to implement an application which can display the response.

Optionally, wherein processing the one or more prompts to identify one or more sensitive data items may comprise determining the context associated with a prompt input and identifying the one or more sensitive data items based on the context. The determination of the context may utilise one or more context determination techniques such as, for example, natural language processing or contextual clustering.

Optionally, sensitive data items may be identified by the platform and displayed via a user interface associated with the platform. Optionally, sensitive data items identified in accordance with the aspect may be identified using a visual indicator such as, for example, a coloured or dashed line. Colours or levels of dashing may correspond to different levels of sensitivity. That is, distinct indicia may be used to distinguish between terms which are very sensitive, mildly sensitive, and not sensitive. For example, a first colour may be used to identify a term identified by the platform as sensitive based on a database of sensitive terms provided by the organisation (e.g. a product or project name) and a second colour may be used to identify a term identified by the platform as sensitive based on a general indication of sensitivity (e.g. a name)

Non-transitory computer readable storage media, systems and processing resources may also be provided which are configured to provide a method in accordance with the first aspect.

### DESCRIPTION

An embodiment will now be described by way of example only and with reference to the following drawings in which:

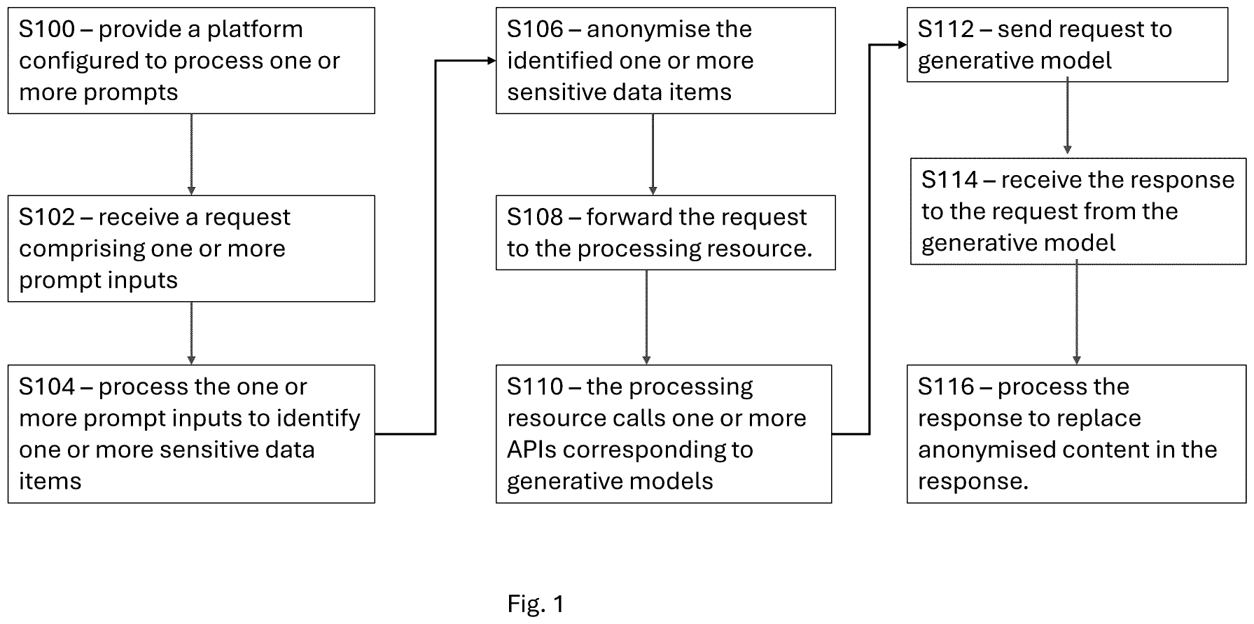

FIG. 1 illustrates a series of steps to be used in processing a request to a generative model in accordance with the embodiment;

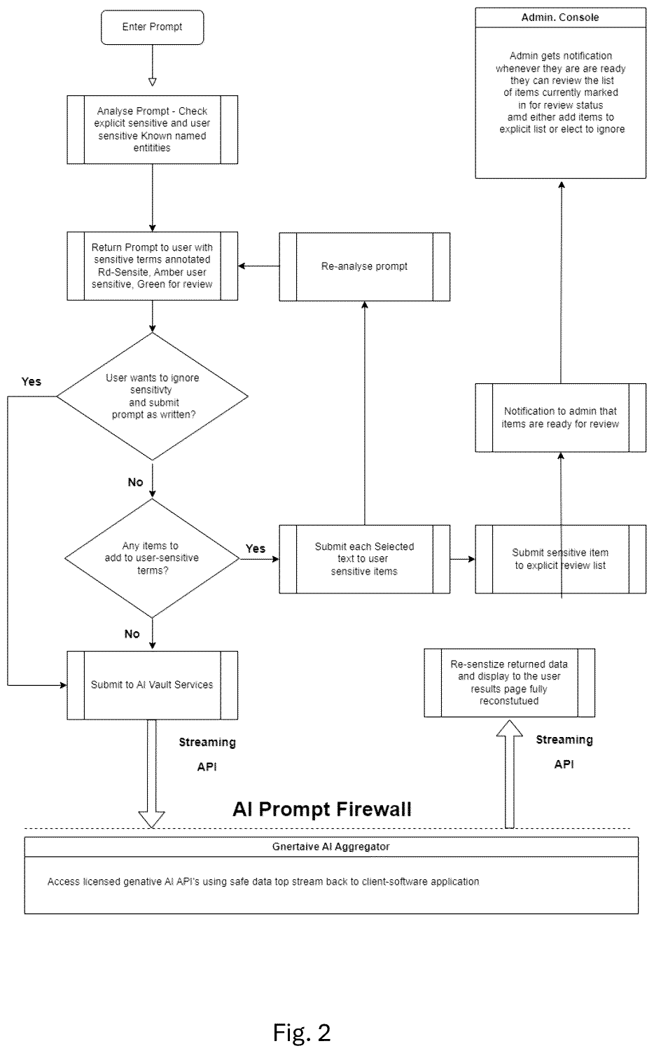

FIG. 2 illustrates the flow of data around a system in accordance with an example implemented using the embodiment; and

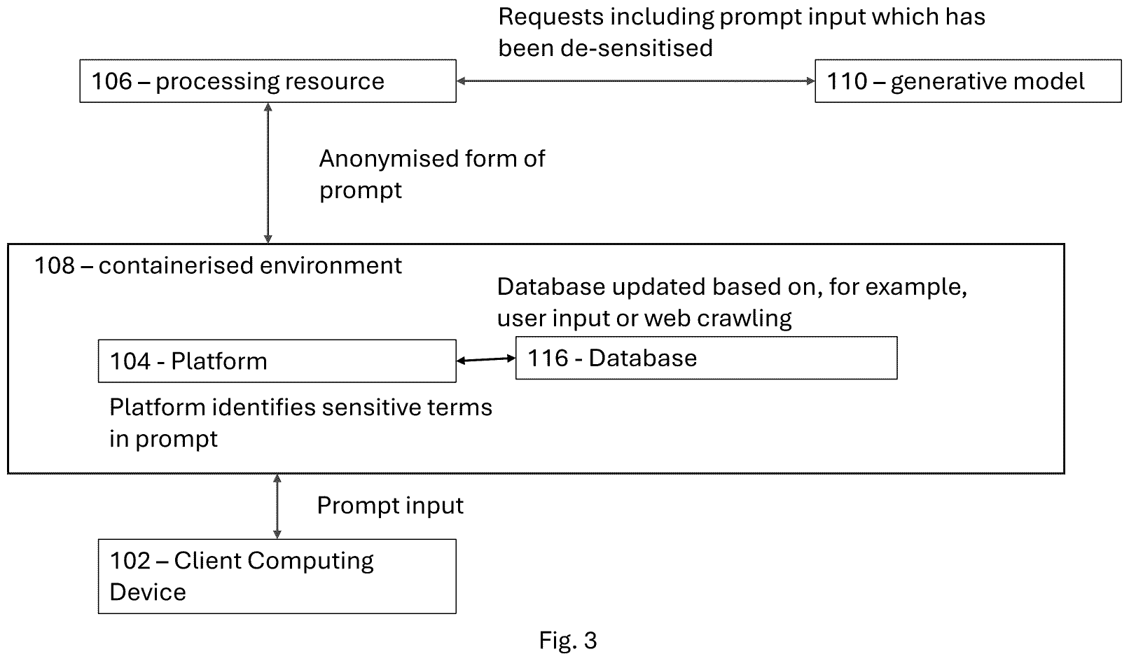

FIG. 3 illustrates the interaction between a client device and a platform in accordance with the embodiment.

We now describe, with reference to FIGS. 1 to 3, a system 100 comprising a client computing device 102, a platform 104 and a processing resource 106. FIG. 1 illustrates the steps of the method. FIG. 2 illustrates some example steps which can be used to implement the method. FIG. 3 schematically illustrates the relationship between the platform 104, the processing resource 106 and the generative model 110. The device 102 is configured to transmit data to the platform 104 using any suitable media or protocol. The platform 104 is implemented using suitable software provided by the processing resource 106. The software implementing the platform 104 may even be installed on the device 102 to enable the platform 104 to run on the device 102 so that data can be received via a user interface on the device 102 and processed on the device using the platform 104. That is to say, the platform 104 is configured to receive input by way of data transmitted from client computing device 102 or via a user interface on client computing device 102 and processed using the platform 104 as a piece of software or hardware running on the client computing device 102.

The platform 104 may be configured to run as part of a containerised environment 108 associated with an organisation which uses the containerised environment 108 to run all of their applications and store all of their data (including sensitive data items). An example of such an environment may be implemented using the Docker platform. The containerised environment 108 may be a secure containerisation environment which is secured by measures such as, for example, image security, access control, network security, monitoring of container activity, secret management, registry protection, orchestration platform security and rootless mode operation.

We will now describe a computer-implemented method of processing a request to one or more generative models 110. Examples of such generative models may include one or more of variational autoencoders, diffusion models and large language models.

The effect of this method may be described as providing:
secure adoption of generative AI within data-sensitive environments;
compliance with regulatory requirements for data protection and confidentiality;
prevention of unauthorised exposure of proprietary or classified information;
maintenance of enterprise-level visibility and control over AI interactions.
facilitation of safe and efficient AI-assisted operations without reliance on external security measures.

In a step S100, the processing resource 106 provides platform 104 configured to process one or more prompt inputs. The platform 104 is provided to containerised environment 108 which may be based at a premises of an organisation. As set out above, the platform 104 may be installed at the client computing device 102 as an application which can receive inputs via a user interface on the client computing device 102. The organisation may be an enterprise which uses the containerised environment 108 to manage all of its software, hardware, applications and data, including sensitive data. The organisation may be a client-side software licensee who has a license to use the platform 104. This may also include databases containing data related to entities managed by the organisation. The sensitive data may be identified by these databases. The identification may also identify a mapping to an anonymised form of the sensitive data. The mapping may deploy a software application which, for example, may determine a hash of an identified sensitive data item to form an anonymised form of the sensitive data item. Alternatively or additionally, the platform 104 may be installed at the processing resource 106 where the computing device 102 can transmit directly to the platform 106.

In a step S102, a user at client computing device 102 provides a request comprises one or more prompt inputs which request content from generative model 110. The request may be provided using a user interface. This may be started by the user just entering a prompt. Alternatively, the user may enter a request and corresponding application code may generate the prompt to accompany the request by determining from the request that specific prompts are necessary. The user interface may be web based and restricted to IP addresses managed by the containerised environment 108. The request identifies the generative model 110 as the destination for the request. The one or more prompts may comprise one or more sensitive data items such as, for example, names, addresses, national insurance numbers, social security numbers etc. Additionally or alternatively, the one or more prompts may reference one or more fields of a database within the containerised environment which contain one or more sensitive data items. The request is provided to the platform 104 using any suitable means.

In a step S104, the platform 104 processes the one or more prompt inputs to identify one or more sensitive data items. Examples of sensitive data may include companies, people, places, locations, products, projects names, percentages, countries, monetary values, percentages, measurements, numbers, parameters, parameter definitions, numerical ranges and compositions which can be present or referenced in a prompt.

The identification may be based on user-defined terms or inputs which are provided to the platform 104 by the user or the organisation. For example, the user defined terms or inputs may comprise names, addresses, social security numbers and the like.

The user or the organisation may define some sensitive terms as highly sensitive (e.g. a name of a high value project) and they may also be identified in the prompts by the platform 104 as sensitive data items. These terms may be defined or described by the system administrators and/or users.

That is, the platform 104 may be configured to apply standard text analysis techniques to the prompt to determine the presence of the user-defined terms or inputs in the prompt to identify the presence of one or more sensitive data items. The text analysis process may comprise one or more of the steps of dimensionality reduction, information retrieval, syntactic parsing, named entity recognition, disambiguation, recognition of pattern identified entities, coreference resolution, sentiment analysis, quantitative text analysis, tokenisation, filtering and stemming. In an example, the prompt input is analysed to determine the presence of explicitly sensitive and/or user sensitive named entities.

The sensitive data items may be identified in one or more databases stored and managed by the containerised environment 108. The administrators who administer the containerised environment 108 may access and maintain a repository of sensitive terms and sensitive data items which may be used to keep the one or more databases up to date. In an example, the prompt input is analysed to determine the presence of explicit sensitive and user sensitive named entities. The databases may be updated in real time to include terms which have become sensitive or terms which are no longer sensitive. Additionally, the administrators and/or users (who have a specified privilege level in the containerised environment 108) may override the identification of sensitive data items. The databases may be stored using storage which is local to the containerised environment 108 and/or the user and/or the administrator. The containerised environment 108 may additionally deploy one or more web crawlers to identify terms which may have become sensitive and update the one or more databases to include those terms.

The sensitive data items may be identified by the platform 104 based on context. That is to say, the platform 104 may apply context determination techniques to the prompt to determine the context of the prompt. This enables sensitive data items to be identified if they are sensitive based on the context of the prompt request. In order to determine the context of the prompt, the platform 104 may apply techniques such as, for example, natural language processing and/or contextual clustering to determine whether a sensitive data item is out of context, i.e. not being used in a context in which it is sensitive. For example, if the prompt says “Write a tender document to be issued to investment banks to bid for RBS to dispose of our private bank Coutts” then the platform, on applying context determination techniques, would identify RBS and Coutts as sensitive data items as they are the names of parties involved in what would be a confidential process. However, if a prompt says “Give me the latest information and market sentiment on RBS” then RBS would not be identified as a sensitive data item. Indeed, the query would be meaningless without the identification of RBS.

In order to determine context from a prompt, the platform 104 may deploy one or more artificial neural networks (ANNs) which are trained to infer context from a text component in a prompt or in a processed version of a prompt. The ANNs which are trained to infer context may deploy network architectures such as, for example, transformers (e.g. BERT) which are trained using supervised learning techniques to identify context in text components of a prompt. The training may be based on datasets related to a wide range of topics and contextual annotation to identify sentiment and intent in a text component of a prompt. Other techniques which apply word embedding, sentence and document embedding, attention mechanisms, masked language modelling and next sentence prediction may also be used. The one or more ANNs may also apply natural language processing using techniques such as tokenisation, stemming, part-of-speech tagging, named entity recognition and word embedding in order to identify context in a text component in a prompt or a processed version of a prompt.

Optionally or additionally, the platform 104 may segment the prompt into its component parts and apply an artificial neural network (ANN) to the component parts to determine the presence of sensitive data items. The ANN may be trained using supervised learning to identify sensitive data items by providing likely combinations of terms containing sensitive data as an input and matching them to sensitive data items as an output using forward-backward propagation.

In an example, the request and the prompts may be returned to the user via a user interface and the sensitive data items may be annotated by the platform 104. The distinction between sensitive data items may be identified using different indicia corresponding to the sensitive data items and their different types. For example, colour-based indicia may be used to distinguish between different types of sensitive data items. In an example, red may be used to indicate sensitive data, amber may be used for data items the user or organisation has identified as sensitive, and green may be used for items which may need to be reviewed.

The user may be offered the opportunity to ignore the sensitivity and submit the prompt in its written form. The user may then ignore the sensitivity. The method may then proceed pass the anonymisation step in step S106. The user may wish to add terms to the sensitive data items at this stage and, in this instance, the selected items may be added to a list of sensitive data items which can be reviewed by the organisation. The administrators may then be notified, and they can review the list and add the terms to the list of sensitive data items to a list. The administrators may ignore the addition of the identified terms. The analysis of the prompt in step S104 may then be repeated in view of the added terms.

In a step S106, the platform 104 is configured to anonymise the one or more identified sensitive data items. This forms anonymised sensitive data items. The anonymisation of the identified sensitive data items may comprise replacing the identified sensitive data items with anonymised data. This may mean that, for example, a sensitive data item such as, for example a name of a person, is replaced with a stored (in a database managed by the containerised environment 108) anonymised version of the sensitive data item. It may be the name replaced with an encrypted version of the name, for example. This may also mean that the sensitive data item is replaced with a numerical version of the sensitive data item. The mapping between the identified sensitive data item and the anonymised version of the name may only be identifiable using the database or known by trusted administrators who administer the containerised environment 108 or the database. The mapping may be kept in a secure computing environment such as a trusted execution environment or an enclave within a trusted execution environment. Optionally or additionally, the anonymised version of the sensitive data item may be generated by processing the identified sensitive data item using an anonymisation algorithm. An anonymisation algorithm may be any algorithm which maps a sensitive data item to a form wherein it does not relate to an identified or identifiable individual or is rendered anonymous in such a way that individuals are not (or are no longer identifiable). An anonymisation algorithm may also be any algorithm which removes direct identifiers (e.g. names, addresses etc) from sensitive data items, aggregates or reduces the precision of a variable (e.g. record a year of birth rather than day, month and year or reduce a level of geo-referencing), generalised meanings (e.g. replacing a detailed description with more general text), restriction of upper or lower ranges (e.g. top coding salaries), obfuscates relational data or obfuscates geo-referenced data. The anonymisation of a sensitive data item may additionally or optionally comprise generating a hash of an identified sensitive data item (e.g. using SHA256 or SHA512). The database where the sensitive data item is identified may comprise an anonymisation indicator which may be used as a variable in an anonymisation indicator (e.g. an integer power which determines the number of hashes which may be used). The platform 104 may also be configured to identify time-sensitive or dynamic data items in the prompt and generate anonymised forms of those data items using any of the approaches described above. The platform 104 can then replace sensitive data items with anonymised forms of the sensitive data items before the prompt is forwarded to the generative model 110.

The one or more databases which are managed and/or implemented in the containerised environment may be used to train any one or more of the ANNs which are implemented by the platform 104. This may utilise supervised or unsupervised learning techniques. This means the ANNs are updated automatically to reflect terms which may, for instance, have become sensitive or which may have been added or removed from the databases. This means the platform 104 can be kept updated automatically and improved to reflect the terms which are identified as sensitive by the organisation associated with the containerised environment 108. Where sensitive terms are identified as highly sensitive, by system administrators or users, the platform 104 will determine the presence of these highly sensitive terms and may completely redact those terms from the prompt. System administrators may issue credentials to specific users which allow them to submit prompts to generative models 110 which contain sensitive data items (or highly sensitive data items) where those terms are not redacted or anonymised by the platform 104. Optionally or additionally, system administrators may issue credentials to specific computing devices which mean that only those computing devices can be used to generate prompts which contain sensitive data items or highly sensitive data items without the data items being anonymised or redacted.

Optionally or additionally, on identifying the presence of or reference to a sensitive data item or highly sensitive term in a prompt, the platform 104 may generate a notification to devices associated with one or more system administrators to alert those system administrators of such an event. This may be the case even if the user is provided with credentials to use sensitive data items or highly sensitive data items. The notification may identify the user, the sensitive or highly sensitive terms in the prompt and the generative model which is the intended destination. The platform 104 provides the option to stop the progression of the prompt entirely or even provides the option to prevent devices associated with the user from generating further prompts and submitting them to the platform 104.

In a step S108, the platform 104 then forwards the request to the processing resource 106. The forwarded request comprises the anonymised prompt input, i.e. where the sensitive data items have been replaced with their anonymised form. The forwarded request comprises an identifier for one or more generative models which are identified in the original request provided in step S102. The platform 104 may also provide other settings with the forwarded request such as, for example, settings of the generative model 110 which are desired by the organisation or the requesting user. These settings may include, for example, temperature, top p (nucleus sampling), max tokens, stop sequences, frequency penalty, presence penalty and import character. That is to say, the sensitive data items are not sent outside of the containerised environment 108. The processing resource 106 may sit within the containerised environment 108 and communicate accordingly with the platform 104. In summary, the platform 104 maps sensitive terms to anonymised forms of those sensitive terms within a locally managed database in the organisations secure infrastructure (i.e. the containerised environment 108) but the sensitive terms are not transmitted outside of the secure infrastructure. That is to say, the platform provides a secure firewall structure which ensures that sensitive data never leaves the containerised environment or becomes exposed to external providers of AI services such as generative models 110.

The prompt and the sensitive data identified to be within the prompt may be recorded by the organisation and used to provide full visibility for the organisation into AI activity undertaken by the members (e.g. employees) of the organisation. This ensures that regulatory compliance can be sustained and protection of, for instance, customer information or confidential information, can be ensured. This can also provide complete control over all AI generated content without external logging of sensitive data or access by third party providers such as, for example, generative models 110.

The identification of sensitive data items may also be improved by leveraging the organisational dataset and used to train, using machine learning principles, the ANN and other trained models which may be used to identify sensitive data items (e.g. those which use text analysis techniques as mentioned above).

In a step S110, the processing resource 106 calls one or more APIs corresponding to the generative models which are identified in the request. The one or more APIs are then used to provide the request to the generative model 110 in a step S112. That is to say, the processing resource 106 acts like an artificial intelligence (AI) aggregator which processes the request without storing or receiving sensitive data. The processing resource 106 provides an intermediary between the platform 104 and the generative model 110. It could be said that the platform and the processing resource 106 acts like a firewall which removes sensitive data items from a prompt to stop that sensitive data from leaving the organisation.

The generative model 110 then generates the response to the request without processing or accessing the sensitive data items. The response is then provided back to the processing resource 106. Alternatively or additionally, the response may be provided directly back to the platform 104 in the containerised environment. The response may comprise the anonymised version of the sensitive data items. For example, the request may be to the generative model 110 for it to draft an email to a person with a name “Terence” which is anonymised as “12567”. The response may comprise the phrase “Dear 12567” at the start of the response.

The respective processing resource 106 or platform 104 receives the response to the request from the generative model in a step S114. If the processing resource 106 receives the response, then it is forwarded to the platform 104 where it is received.

In a step S116, the processing resource 106 is configured to determine the presence of the anonymised data items in the received response. The anonymised data items are then replaced with the original sensitive data items. That is to say, “12567” would be replaced with “Terence”. That is to say, the anonymised content in the response is replaced with the sensitive data items which were anonymised (in step S106) to remove those sensitive data items in order to prevent them being used by or accessed by the generative model 110. The response is then provided via a user interface on computing device 102 (or another computing device). The response may be provided via a messaging application or an email application. That is to say, the platform “re-sensitises” the response to replace the anonymised terms.

The method describes how the organisation associated with the containerised environment 108 and who is running the platform 104 provided by the processing resource 106 has complete visibility and control of all AI activity conducted by its members and that this is not available to the Generative AI (GAI) or to any of the generative models used by the organisation. What is provided is a system and method for ensuring the secure and controlled use of generative artificial intelligence (AI) by organisations handling sensitive data. More particularly, the invention provides a mechanism for preventing the unauthorised exposure of sensitive data (e.g. confidential information) while leveraging the benefits of generative AI models.

In short, the described system and method provide a robust and scalable framework for enabling generative AI within regulated industries while mitigating the risks associated with data leaks and unauthorised access.

It should be noted that the above-mentioned aspects and embodiments illustrate rather than limit the disclosure, and that those skilled in the art will be capable of designing many alternative embodiments without departing from the scope of the disclosure as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. In the present specification, “comprises” means “includes or consists of” and “comprising” means “including or consisting of”. The singular reference of an element does not exclude the plural reference of such elements and vice-versa. The disclosure may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A computer-implemented method of processing a request to a generative model, the method implemented by a processing resource, the method comprising:
providing a platform configured to process one or more prompt inputs, wherein the platform is configured to:
receive a request comprising one or more prompt inputs from a computing device, wherein the request is directed to the generative model;
process the one or more prompt inputs to identify one or more sensitive data items associated with the prompt input;
anonymise the identified sensitive data items prior to forwarding the prompt input to the generative model to form an anonymised prompt input; and
forward the request to the generative model, wherein the request comprises the anonymised prompt input;
wherein the method further comprises:
receiving the response to the request from the generative model;
processing the response to replace anonymised content in the response with the corresponding one or more sensitive data items.

2. The method according to claim 1, wherein anonymising the identified sensitive data items comprises replacing the identified sensitive data items with anonymised data.

3. The method according to claim 2, wherein the anonymised data is generated by processing the identified sensitive data item to generate an anonymised form of the identified sensitive data item.

4. The method according to claim 3 wherein the generation of the anonymised form of the identified sensitive data item comprises generating a hash of the identified sensitive data item.

5. The method according to claim 3, wherein the anonymised form is generated based on an anonymisation indicator stored in a client environment.

6. The method according to claim 1, wherein the identification of sensitive data items is based on one or more user-defined terms or inputs.

7. The method according to claim 1, wherein the identification is sensitive data items is performed using a trained neural network.

8. The method according to claim 1, wherein the anonymisation of the one or more sensitive data items is based on a mapping between the sensitive data item and an anonymised form of the sensitive data item.

9. The method according to claim 1 wherein the platform is configured to be accessed via a containerised environment associated with user data.

10. The method according to claim 1 wherein the method further comprises:
processing the prompt input to identify time-sensitive or dynamic data;
determining whether the time-sensitive or dynamic data is associated with at least one sensitive data item; and
processing the time-sensitive or dynamic data to generate an anonymised form of the time-sensitive or dynamic data.

11. The method according to claim 10, wherein the method further comprises processing the response to replace anonymised time-sensitive or dynamic content with corresponding one or more time sensitive or dynamic data items.

12. The method according to claim 1, wherein the response is provided on a computing device via a user interface.

13. The method according to claim 1, wherein processing the one or more prompts to identify one or more sensitive data items may comprise determining the context associated with a prompt input and identifying the one or more sensitive data items based on the context.

14. A non-transitory computer readable storage medium having stored thereon executable instructions that, as a result of being executed by a processor of a computer system, cause the computer system to at least perform the method of claim 1.

15. A system configured to implement the method of claim 1.

16. A processing resource comprising a processor and memory including executable instructions that, as a result of execution by the processor, causes the reader to perform the method of claim 1.
